(19) United States
(12) Patent Application Publication
(10) Pub. No.: US 2019/0364317 A1
(43) Pub. Date: Nov. 28, 2019

(54) BASE LINEAR STREAM CREATER FOR PERSONALIZED CHANNELS

(71) Applicant: ARRIS Enterprises LLC, Suwanee, GA (US)

(72) Inventor: Matthew A. Milford, Waxhaw, NC (US)

(21) Appl. No.: 16/396,638

(22) Filed: Apr. 27, 2019

Related U.S. Application Data
(60) Provisional application No. 62/665,677, filed on May 2, 2018.

(51) Int. Cl. H04N 21/2668; H04N 21/2381; H04N 21/81; H04N 21/2665; H04N 21/2187

(52) U.S. Cl. CPC H04N 21/2668; H04N 21/2381; H04N 21/2187; H04N 21/2665; H04N 21/812

(57) ABSTRACT

A method is provided for establishing a personalized channel, with a request received to establish a personalized channel to be deliverable to a prescribed set of client devices as a linear channel streaming adaptive bit rate (ABR) video content. Responsive to the request, a base linear stream manifest is generated for the personalized channel. The base linear stream includes a first sequence of in-band signaling markers each representing at least one chunk of content. Each of the in-band signaling markers in the first sequence have an annotation representing a point of decision and specifying a network location of a decisioning engine that resolves the decision by specifying a content asset to be streamed at a specified time. The first sequence of in-band signaling markers spans a continuous duration of time without gaps over which ABR video content to be specified by the decisioning engines is to be inserted.

### CROSS REFERENCE TO RELATED APPLICATION

This application claims priority under 35 U.S.C. § 119(e) from earlier filed U.S. Provisional Application Ser. No. 62/665,677, filed May 2, 2018 which is incorporated herein by reference in its entirety.

### BACKGROUND

Subscription based video content service providers employ networks such as direct broadcast satellite (DBS), over-the-air, cable or telecommunication distribution systems to distribute video content as linear video or video-on-demand (VOD) streams. Recently, these video content providers have overlaid adaptive bitrate (ABR) systems to satisfy their subscribers' demands for IP-based over-the-top services as well as linear video or video-on-demand (VOD) streams.

Consumers of linear and VOD content have an ever-growing number of content sources available to them, and they want to receive that content easily on a wide variety of devices. For instance, service providers often provide hundreds of different channels for viewers to choose from. Additionally, a vast array of Internet-based sources of content are also available to consumers, including video, still images and graphics. To assist consumers in selecting and receiving the video content that they are most interested in, subscription-based video content service providers would like to offer personalized channels targeted or personalized for individual consumers or groups of consumers that have one or more attributes or characteristics in common. For instance, personalized channels may be targeted to groups of consumers who are physically located in common regional markets.

### SUMMARY

In accordance with one aspect of the techniques described herein, a method is provided for establishing a personalized channel. In accordance with the method, a request is received to establish a personalized channel that is to be deliverable to a prescribed set of client devices as a linear channel streaming adaptive bit rate (ABR) video content. Responsive to the request, a base linear stream manifest is generated for the personalized channel. The base linear stream includes a first sequence of in-band signaling markers each representing at least one chunk of content. Each of the in-band signaling markers in the first sequence have an annotation representing a point of decision and specifying a network location of a decisioning engine that resolves the decision by specifying a content asset to be streamed at a specified time. The first sequence of in-band signaling markers spans a continuous duration of time without gaps over which ABR video content to be specified by the decisioning engines is to be inserted.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows one example of an operating environment in which the techniques, systems and devices described herein may operate.

FIG. 2 shows one example of the personalized channel generation system shown in FIG. 1.

FIG. 3(a) shows a representation of an illustrative base linear stream 300 that is paced out in accordance with the real-world clock time; FIG. 3(b) shows one example of a personalized linear stream after the manifest delivery controller (MDC) has resolved the decisions required by the content replacement markers.

FIG. 4 illustrates a block diagram of one example of a computing apparatus that may be configured to implement or execute one or more of the processes performed by any of the various devices shown herein, including but not limited to the Base Linear Stream Controller (BLSC).

### DETAILED DESCRIPTION

As previously mentioned, subscription-based video content service providers would like to offer personalized channels over their networks, which are targeted or personalized for individual consumers or groups of consumers. One implementation may deliver the personalized channels to consumers as ABR streams. The ABR streams may be obtained using VOD manifest files that function as live manifest files, but which are able to provide the consumer with VOD content as well as linear content. In this way the consumer is able to experience a customized selection of VOD content as live content just as if it were available on conventional channels.

Adaptive bit rate streaming is a technique for streaming multimedia where the source content is encoded at multiple bit rates. It is based on a series of short progressive content files applicable to the delivery of both live and on demand content. Adaptive bit rate streaming works by breaking the overall media stream into a sequence of small file downloads, each download loading one short segment, or chunk, of an overall potentially unbounded content stream.

As used herein, a chunk is a small file containing a short video segment (typically 2 to 10 seconds but can be as short as a single frame in some implementations) along with associated audio and other data. Sometimes, the associated audio and other data are in their own small files, separate from the video files and requested and processed by the ABR client(s) where they are reassembled into a rendition of the original content. Adaptive streaming may use, for instance, the Hypertext Transfer Protocol (HTTP) as the transport protocol for these video chunks. For example, ‘chunks’ or ‘ chunk files’ may be short sections of media retrieved in an HTTP request by an ABR client. In some cases these chunks may be standalone files, or may be sections (i.e. byte ranges) of one much larger file. For simplicity the term ‘ chunk’ is used to refer to both of these cases (many small files or fewer large files).

Adaptive bit rate streaming methods have been implemented in proprietary formats including HTTP Live Streaming (“HLS”) by Apple, Inc., and HTTP Smooth Streaming by Microsoft, Inc. adaptive bit rate streaming has been standardized as ISO/IEC 23009-1, Information Technology—Dynamic Adaptive Streaming over HTTP (“DASH”): Part 1: Media presentation description and segment formats. Although references are made herein to these example adaptive bit rate protocols, it will be recognized by a person having ordinary skill in the art that other standards, protocols, and techniques for adaptive streaming may be used.

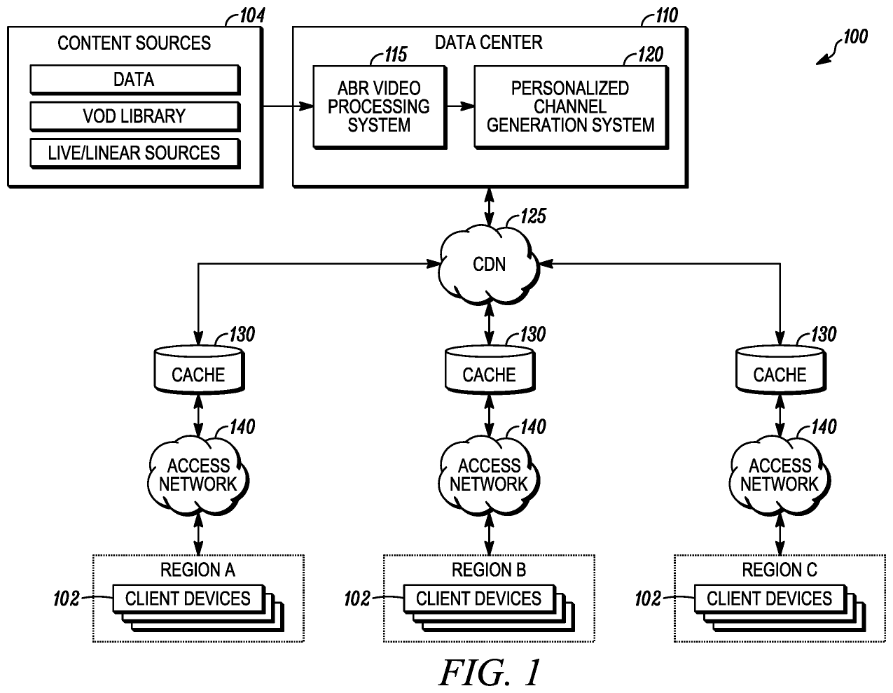

FIG. 1 shows one example of an operating environment in which the techniques, systems and devices described herein may operate. In particular, FIG. 1 depicts a high-level functional block diagram of a representative adaptive bit rate system 100 that delivers content to adaptive bit rate client devices 102. An adaptive bit rate client device 102 is a client device capable of providing streaming playback by requesting an appropriate series of segments from an adaptive bit rate system. The ABR client devices 102 associated with users or subscribers may include a wide range of devices, including, without limitation, digital televisions, set top boxes (STBs), digital media players, mobile communication devices (e.g., smartphones) video gaming devices, video game consoles, video teleconferencing devices, and the like.

The content made available to the adaptive bit rate system 100 may originate from various content sources represented by content source 104, which may provide content such as live or linear content, VOD content and Internet-based or over-the-top (OTT) content such as data, images, graphics and the like. The content is provided to a data center 110 that includes an ABR video processing system 115 and a personalized channel delivery system 120. ABR video processing system 115 is responsible for ingesting the content in its native format (e.g., MPEG, HTMLS, JPEG, etc.) and processing it as necessary so that it can be transcoded and packaged. The ABR video processing system 115 also includes the transcoders and packagers that are responsible for preparing individual adaptive bit rate streams. A transcoder/packager is designed to encode, then fragment the media files into chunks or segments and to encapsulate those files in a container expected by the particular type of adaptive bit rate client. The adaptive bit rate segments are available at different bit rates, where the segment boundaries are aligned across the different bit rates so that clients can switch between bit rates seamlessly at the segment boundaries.

Along with the delivery of media, the packagers create the manifest files for each type of adaptive bit rate streaming protocol that is employed. In adaptive bit rate protocols, the manifest files generated may include a main or variant manifest and a profile or playlist manifest. The main manifest describes the various formats (resolution, bit rate, codec, etc.) that are available for a given asset or content stream. For each format, a corresponding profile manifest may be provided. The profile manifest identifies the media file chunks/segments that are available to the client. The ABR client determines which format the client desires, as listed in the main manifest, finds the corresponding profile manifest and location, and then retrieves media segments referenced in the profile manifest.

The individual adaptive bit rate streams are typically posted to an HTTP origin server (not shown) or the like so that they can be accessed by the client devices 102 over a suitable content delivery network (CDN) 125, which may be in communication with various edge caches 130. In some cases the edge caches 130 are in turn in communication with one or more client devices 102 in one or more regions through one or more access networks 140 that each serve a designated region. By way of a non-limiting example, FIG. 1 depicts an example of the data center 110 in communication with three regions A, B and C. However, the central data center 110 can be in communication with any desired number of regions. CDN 125 and access networks 140 may comprise any suitable network or combination of networks including, without limitation, IP networks, hybrid fiber-coax (HFC) networks, and the like.

It should be noted that the various systems and components of the adaptive bit rate system 100 shown in FIG. 1 may be in any suitable location or locations. To the extent they are not co-located, they may communicate over one or more networks such as an IP CDN.

The various manifests that have been generated by the ABR video processing system 115 are provided to personalized channel generation system 120, which creates the personalized channels based on such factors as individual profiles of subscribers' interests, preferences and specific content selections, subscriber geographical locations, and/or genres of content. For instance, by way of example, personalized channels may be created for all subscribers in particular cities or other market regions, other personalized channels may be created for individual subscribers, and yet other personalized channels may be created for subscribers who, by way of example, are fans of certain genres (e.g., science fiction, westerns) of movies or who are located in a particular region and are interested in local sports events occurring that region.

The personalized channel generation system 120 selects the content assets and events that are to be included in the video stream for each personalized channel and obtains, for each content asset and event, its corresponding manifest. The personalized channel generation system 120 then assembles the manifest for each channel into a rolling manifest that can be delivered to the ABR client device(s) that are to receive that personalized channel.

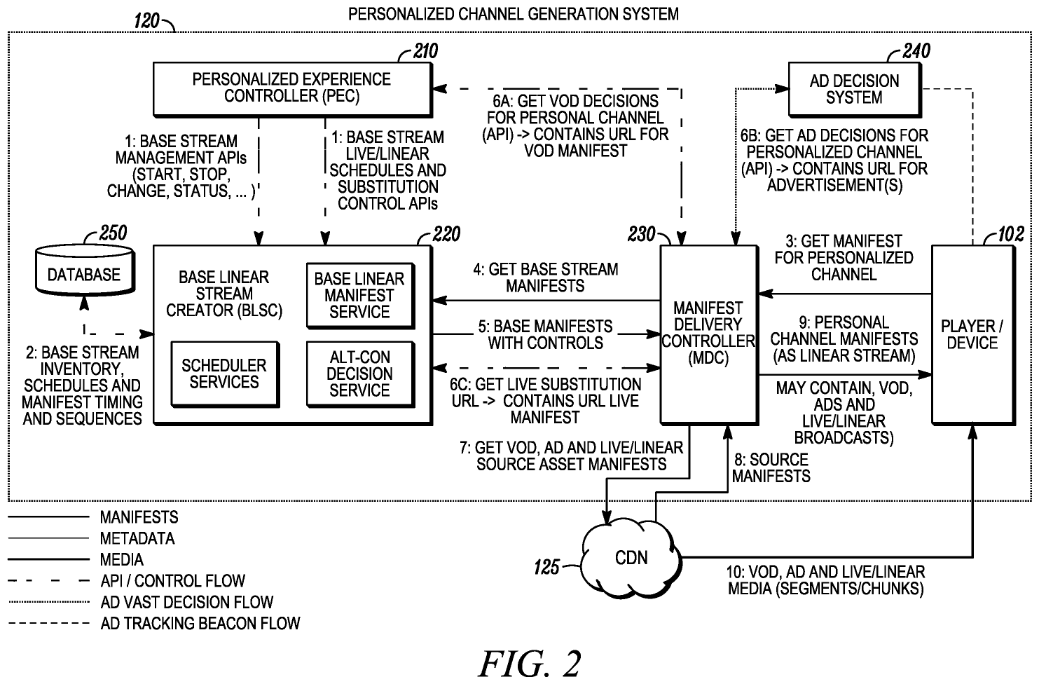

FIG. 2 shows one example of the personalized channel generation system 120. The personalized channel generation system 120 includes a personalized experience controller (PEC) 210, a base linear stream creator (BLSC) 220, a video manifest manipulator, referred to herein as manifest delivery controller (MDC) 230, an ad decision system 240 and a database 250. The PEC 210 serves as a decisioning engine that is responsible for selecting the content assets and live events that are to be included in the video stream for each personalized channel. The BLSC 220 is responsible for generating a manifest for each base linear stream. The base linear stream serves as a template for each video stream provided by each personalized channel.

As explained in more detail below, the base linear stream manifest includes a series of content replacement markers that serve as decision points at which different content assets can be inserted for different personalized channels. The content to be inserted is selected by one or more decisioning engines. Interspersed among the content replacement markers may be other markers, such as those defining times as which live content is to be presented and times at which advertisements are to be inserted. The MDC 230 obtains the base linear stream manifests for the personalized channels from the BLSC 220 and requests from the appropriate decisioning engine (e.g., the PEC 210 or the ad decision system 240) a resolution to the decisions presented by the content replacement markers. Once the content assets have been specified for each content replacement marker in the base linear stream of a particular personalized channel, the MDC 230 obtains the manifests for each content asset and each scheduled live event and advertisement that is to be presented on the personalized channel and assembles them into a personalized channel manifest that can be provided to ABR client device(s) requesting that personalized channel as a rolling manifest that can deliver a linear video stream.

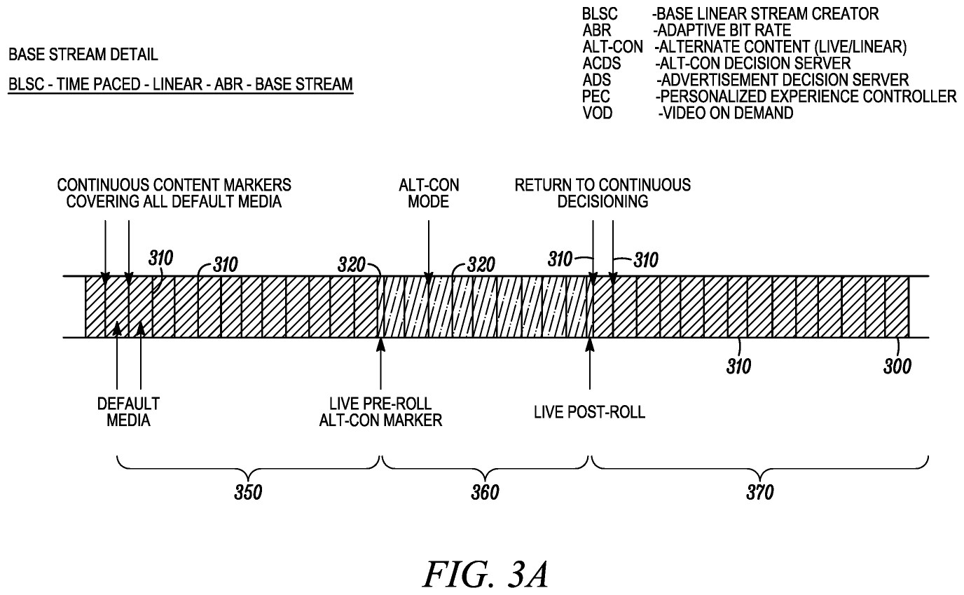

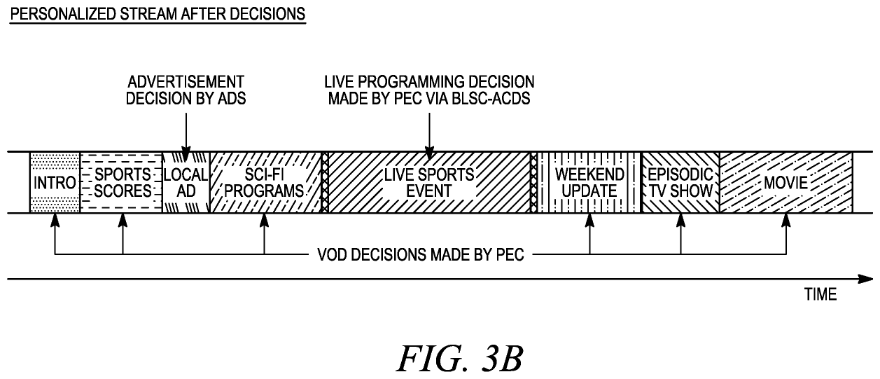

FIG. 3(a) shows a representation of an illustrative base linear stream 300 that is paced out in accordance with the real-world clock time, where time proceeds from left to right. As shown, the base linear stream 300 includes a continuous series of markers that represent one chunk of content That is, the time between adjacent markers corresponds to the duration of one chunk.

The in-band markers may be either content replacement markers 310 or alternative content markers 320. Each marker includes an annotation that specifies the decisioning engine that determines the content asset (e.g., a VOD asset, a live event) to be inserted at that time. The in-band signaling markers may be based on any suitable standard such as Society of Cable Telecommunications Engineers (SCTE) 35, for example. Alternatively, proprietary in-band signaling markers may be employed instead.

In the illustrative base linear stream 300 of FIG. 3(a), a first portion 350 of finite duration spanning multiple segments contains a continuous sequence of content replacement markers 310. Since the content replacement markers 310 each have a duration of one segment and are spaced one segment apart, they collectively ensure that the entire duration of the first portion 350 can be replaced with content assets that have not yet been specified without any gap in time. A second portion 360 of the base linear stream 300 begins and ends with alternative content markers 320, indicating that a live event is to be presented during this second portion 360. The first alternative content marker 320 may include an annotation specifying the location of the manifest for a previously provisioned pre-roll introduction to the live event and an annotation specifying the location of the manifest for the live event itself. A similar alternative content marker 320 that includes a previously provisioned post-roll out of the live event denotes the end of the second portion 360 of the base linear stream. The process of generating a manifest for a live base linear stream may continue in this manner so that the personalized channel can be presented as a linear channel. For instance, in FIG. 3(a), after conclusion of the live event, the live base linear stream presents another continuous sequence of content replacement markers 310 during a third portion 370 in which replacement content may be inserted without a gap in time. The entire process may continue endlessly or for a finite period of time (e.g., 8 hours a day) so that the personalized channel are available in the same way that conventional channels are available. That is, in some cases the ABR stream delivered on the personalized channel may be a never-ending ABR video stream unless and until an external event causes termination of the ABR video stream.

FIG. 3(b) shows one example of a personalized linear stream after the MDC has resolved the decisions required by the content replacement markers. As shown, the linear stream includes VOD assets such as sports scores, a sci-fi program, a movie, and so on, as well as a pre-scheduled live event and a local advertisement tailored to the particular market region to which the personalized linear stream is being delivered. If, for instance, this particular personalized channel has been established for one particular subscriber, then the content assets and live events have been preselected by the subscriber or have otherwise been determined to be of interest to the subscriber.

Returning to FIG. 2, the flow of communications between the various components and systems shown therein that are used to deliver a personalized channel to the client device 102 will now be described. In this example the functions performed by the BLSC 220 are illustrated as being performed by three functional modules: schedule services module 222, base linear manifest service module 224 and alternative content decision service module 226. The schedule services module 222 is largely responsible for polling the PEC 210 on a regular basis to refresh the list of available VOD, live events and advertisements that have been scheduled for insertion into the video stream. The base linear manifest service module 224 is largely responsible for generating the base linear stream manifests and serving them to the MDC 230 when requested. The alternative content decision service module 226 is largely responsible for providing the URLs for live events.

As indicated at 1, the PEC 210 provides the BLSC 220, via suitable APIs exposed by the BLSC 220, with basic information to be incorporated into the base linear stream for the particular personalized channel being developed. For example, the PEC 210 will provide a base URL for specifying the network location of the source(s) from which manifest URLs may be obtained, a schedule of live events and advertisements that are to be inserted into the video stream, and so on. At 2, this information is stored by the BLSC 220 in the database 250. Given this information from the PEC 220, the BLMS 220 in the BLSC 220 is able to create the manifest for the base linear stream.

At 3 the ABR client device 102 requests the manifest for the personalized channel in order to begin playing the personalized channel. The MDC 230 in turn, requests the base linear stream manifest from the BLMS 222 at 4. In one embodiment, the requests may be sent using HTTP Get requests. At 5, the BLSC 220 sends the base linear manifest with the various markers to the MDC 230. The MDC 230 continuously looks ahead through the base linear manifest for markers indicating when content such as upcoming VOD assets, live events or advertisements are scheduled for presentation. The MDC 230 obtains from the marker annotations the URLs for the sources that are to provide the URLs for VOD content assets, live events and advertisements.

For instance, the MDC 230 may determine from a content replacement marker that it is to obtain a resolution to a VOD asset decision from the PEC 210. Accordingly, at 6a the MDC 230 sends a request to the PEC 210 to get the URL for the VOD asset manifest for the VOD asset that is to be inserted into the video stream on the personalized channel. The PEC 210 then returns the appropriate URL. Likewise, at 6b, the MDC 230 may identify an advertisement marker in the manifest for the base linear stream and in response obtains a URL from the ad decision system 240 for the URL for an advertisement that is to be inserted at some particular time in the video stream. Finally, the MDC 230 may determine from an alternative content marker that an upcoming live event is scheduled at a certain time and requests and receives the URL for this live event from the BLSC 220 at 6d. In this case the BLSC 220 is acting as an alternative content decision service that provides the URL for the live event. Of course, in other implementations, the MDC 230 may be directed to a different alternative content decision service to get the URL for the live event.

Once the MDC 230 has obtained the URLs for the various assets and events, it sends an HTTP GET request or the like over, e.g., the CDN 125, to obtain their manifests at 7. The MDC 230 receives the manifests and 8 and assembles them into a rolling manifest that may be delivered as a rolling manifest to the requesting ABR client device(s) 102 at 9, thereby appearing to the ABR client device(s) 102 as a linear stream. The ABR client device(s) 102 is thus able to use the rolling manifest to obtain the media over the CDN 125 in a conventional manner at 10.

In some cases the BLSC 220 may be able to access content that can be provided in the base linear stream in the event that the MDC 230 is unable to obtain content decisions form a decisioning engine such as the PEC 210 or ad decision 240 due to a failure. In some cases the BLSC 220 may also be able to insert into the manifest for the base linear stream content that can serve as a transition into and/or out of live or linear programming.

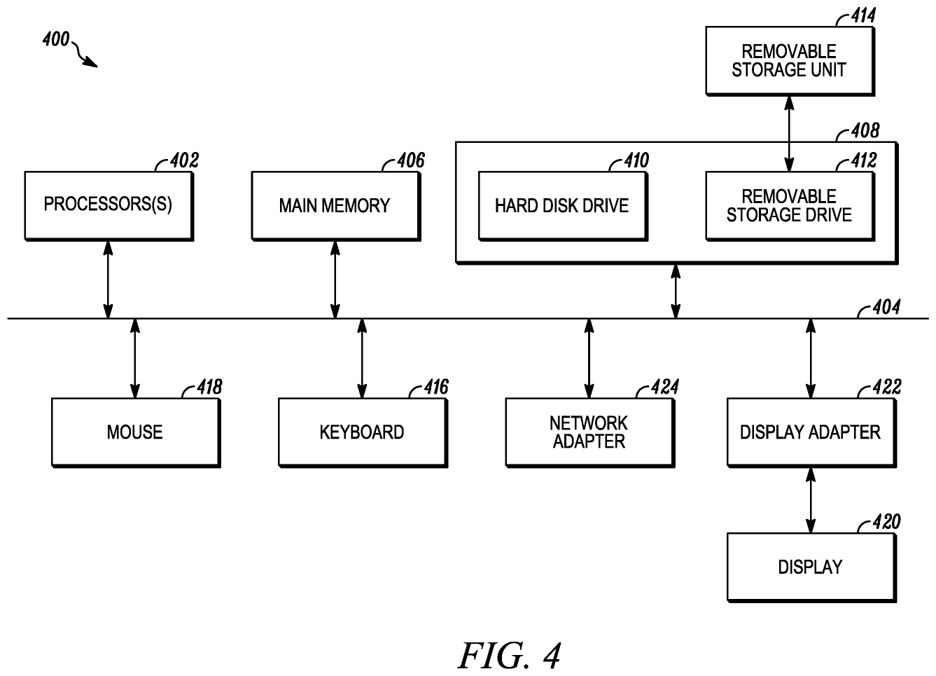

FIG. 4 illustrates a block diagram of one example of a computing apparatus 400 that may be configured to implement or execute one or more of the processes performed by any of the various devices shown herein, including but not limited to the BLSC 220. It should be understood that the illustration of the computing apparatus 400 is a generalized illustration and that the computing apparatus 400 may include additional components and that some of the components described may be removed and/or modified without departing from a scope of the computing apparatus 400.

The computing apparatus 400 includes a processor 402 that may implement or execute some or all of the steps described in the methods described herein. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, where a copy of the program code for one or more of the processes depicted in FIGS. 2-5 may be stored. The removable storage drive 412 reads from and/or writes to a removable storage unit 614 in a well-known manner.

As disclosed herein, the term “memory,” “memory unit,” “storage drive or unit” or the like may represent one or more devices for storing data, including read-only memory (ROM), random access memory (RAM), magnetic RAM, core memory, magnetic disk storage mediums, optical storage mediums, flash memory devices, or other computer-readable storage media for storing information. The term “computer-readable storage medium” includes, but is not limited to, portable or fixed storage devices, optical storage devices, a SIM card, other smart cards, and various other mediums capable of storing, containing, or carrying instructions or data. However, computer readable storage media do not include transitory forms of storage such as propagating signals, for example.

User input and output devices may include a keyboard 616, a mouse 618, and a display 620. A display adaptor 622 may interface with the communication bus 604 and the display 620 and may receive display data from the processor 602 and convert the display data into display commands for the display 620. In addition, the processor(s) 602 may communicate over a network, for instance, the Internet, LAN, etc., through a network adaptor 624.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between to or more computers. All functions performed by the various components, modules, engines, systems, apparatus, interfaces or the like may be collectively performed by a single processor or each component, module, engine, system, apparatus, interface or the like may have a separate processor.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein may be combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

1. A method for establishing a personalized channel, comprising:
receiving a request to establish a personalized channel that is to be deliverable to a prescribed set of client devices as a linear channel streaming adaptive bit rate (ABR) video content; and
responsive to the request, generating a base linear stream manifest for the personalized channel, the base linear stream including a first sequence of in-band signaling markers each representing at least one chunk of content, each of the in-band signaling markers in the first sequence having an annotation representing a point of decision and specifying a network location of a decisioning engine that resolves the decision by specifying a content asset to be streamed at a specified time, the first sequence of in-band signaling markers spanning a continuous duration of time without gaps over which ABR video content to be specified by the decisioning engines is to be inserted.

2. The method of claim 1, wherein the decisioning engines respectively specifying the content assets provide network locations at which the content assets are available.

3. The method of claim 1, wherein the base linear stream includes a second sequence of in-band signaling markers each representing at least one chunk of content, each of the in-band signaling markers in the second sequence having an annotation representing a point of decision and specifying a network location of a decisioning engine that resolves the decision by specifying a content asset to be inserted at a specified time, the second sequence of in-band signaling markers spanning a continuous duration of time without gaps over which ABR video content to be specified by the decisioning engines is to be inserted.

4. The method of claim 1, wherein at least one of the content assets is a video-on-demand (VOD) asset.

5. The method of claim 3, wherein at least one of the content assets is an advertisement asset.

6. The method of claim 5, wherein at least another of the content assets is a live event.

7. The method of claim 1, further comprising sending the base linear stream manifest to a video manifest manipulator for assembling a personalized channel manifest from the base linear stream manifest and delivering the personalized channel manifest to a prescribed set of client devices as a rolling manifest.

8. The method of claim 1, wherein base liner stream manifest represents a never-ending ABR video stream unless and until an external event causes termination of the ABR video stream.

9. The method of claim 1, wherein receiving the request includes receiving a schedule of live events and advertisements to be included on the personalized channel.

10. The method of claim 7, wherein sending the base linear stream manifest includes pacing out the base linear stream manifest in accordance with real-world clock time.

11. The method of claim 1, further comprising specifying a content asset to be streamed at a specified time in the event of a failure by a decisioning engine to resolve a decision.

12. The method of claim 6, further comprising specifying a content asset to be streamed at a specified time, the specified content asset serving as a transition into or out of the live event.

13. A computer-readable medium having computer executable instructions for implementing a method comprising:
receiving a request to provide a base linear stream manifest for a personalized channel; and
responsive to the request, generating a base linear stream manifest for the personalized channel, the base linear stream including a first sequence of in-band signaling markers each representing at least one chunk of content, each of the in-band signaling markers in the first sequence having an annotation representing a point of decision and specifying a network location of a decisioning engine that resolves the decision by specifying a content asset to be streamed at a specified time, the first sequence of in-band signaling markers spanning a continuous duration of time without gaps over which ABR video content to be specified by the decisioning engines is to be inserted.

14. The computer-readable medium of claim 13, further comprising sending the base linear stream manifest to a video manifest manipulator that delivers an ABR manifest to ABR client devices, the ABR manifest being generated using the base linear stream manifest.

15. The computer-readable medium of claim 13, wherein at least one of the content assets is a VOD asset and another of the content assets is a live event.

16. The computer-readable medium of claim 15, wherein a system generating the base linear stream manifest includes the decision engine that resolves the decision to specify the live event.

17. The computer-readable medium of claim 13, wherein the decisioning engines respectively specifying the content assets provide network locations at which the content assets are available.

18. The computer-readable medium of claim 13, wherein the base linear stream includes a second sequence of in-band signaling markers each representing at least one chunk of content, each of the in-band signaling markers in the second sequence having an annotation representing a point of decision and specifying a network location of a decisioning engine that resolves the decision by specifying a content asset to be inserted at a specified time, the second sequence of in-band signaling markers spanning a continuous duration of time without gaps over which ABR video content to be specified by the decisioning engines is to be inserted.

19. The computer-readable medium of claim 13, wherein base liner stream manifest represents a never-ending ABR video stream unless and until an external event causes termination of the ABR video stream.

20. The computer-readable medium of claim 13, wherein the request to receive the base linear stream for the personalized channel includes a request that at least one of the content assets specified by at least one of the in-band signaling markers is a prescribed content asset based at least in part on an individual profile of at least one subscriber.
